(19) United States
(12) Patent Application Publication
(10) Pub. No.: US 2007/0216855 A1
(43) Pub. Date: Sep. 20, 2007

(54) Spectacles With Mounting and Lenses Interconnected by Strap

(76) Inventor: Vittorio Tabacchi, Pieve Di Cadore (IT)

Correspondence Address: RATNERPRESTIA, P O BOX 980, VALLEY FORGE, PA, 19482-0980, US

(21) Appl. No.: 11/587,554

(22) PCT Filed: May 13, 2004
(86) PCT No.: PCT/IT04/00264

§ 371 Date: Oct. 25, 2006

(51) Int. Cl. G02C 1/04

(52) U.S. Cl. 351/106

(57) ABSTRACT

Spectacles are described which include a mounting and respective lenses and also strap interconnector for retaining the lenses on the mounting. The strap interconnector is capable of at least partially surrounding the lens and being secured to the mounting in order to retain the lens on the latter. The strap interconnector includes, for each lens, a single strap segment with at least two lengths of segment having a different cross-section. The profile of the section of one of the lengths is defined by a first and a second profile part. The first profile part is capable of being retained in a respective groove of the mounting. The second profile part of the section is capable of engaging a peripheral flute provided in the lens thickness. The profile of the cross-section of the other strap length has substantially the shape of the second profile part such that the corresponding strap length surrounds the lens, engaging the flute.

This application is a U.S. National Phase Application of PCT International Application PCT/IT2004/000264 and incorporated by reference herein.

### TECHNICAL FIELD

The present invention, in general, concerns improved spectacles with mounting and lenses interconnected by a strap.

### BACKGROUND OF THE INVENTION

In the technical field of reference it is known to produce spectacles in which the lenses are retained on mountings including lens-holding rims which completely or only partially surround the lens, by means of strap interconnecting means. Typically, a resiliently flexible strap is provided, customarily of nylon, arranged to surround sections of the lens edge and to be engaged in corresponding holes in the mounting, and also capable of being tensioned so as to render the mounting and the lenses firmly connected to one another.

A known type of such mountings for spectacles provides, for each lens, a mounting member arranged to partially surround the lens and a connecting strap extended to encompass the remaining edge part of the lens, coupling means being provided for securing the strap at opposed lateral regions of the lens, in particular in the lug region and the region of the intermediate nasal support bridge. Provision is also made for the interposition of a resilient gasket, for example produced by a separate and different second filiform member, between the mounting member and the facing lens edge, constituting a yielding supporting cushion between the lens and the mounting, capable of preventing possible breakage of the lens when locking same on the mounting, as a result of tensioning of the connecting strap.

### BRIEF DESCRIPTION OF THE INVENTION

A principal aim of the present invention is to provide spectacles with mounting and lenses interconnected by strap, in which the mounting of the lenses on the mounting is simplified and facilitated, with a reduced number of components and simplified assembly operations. Another aim is that of simplifying the structure of the mounting arranged to receive lenses interconnected by the strap, limiting or eliminating the provision of coupling means on the mounting for securing the connecting strap with relative tensioning.

Yet another aim is that of providing spectacles in which the same strap interconnecting means can serve for the mounting of lenses of a different dimension or style, thus simplifying the production cycles with greater standardization of the components required.

These and other aims which will be clearly revealed hereinafter are achieved by the present invention by means of spectacles including a mounting and respective lenses and also strap interconnecting means for the retention of the lenses on the mounting. The strap interconnecting means is capable of at least partially surrounding the lens and is secured to the mounting for retaining the lens thereon. The strap interconnecting means includes, for each lens, a single strap segment with at least two lengths of segment having a different cross-section, the profile of the cross-section of one of the lengths is defined by a first and a second profile part. The first profile part is capable of being retained in a respective groove of the mounting, and the second profile part of the cross-section is capable of engaging a peripheral flute provided in the lens thickness. The profile of the cross-section of the other strap length has substantially the shape of said second profile part such that the other strap length surrounds the lens and engages the flute.

### BRIEF DESCRIPTION OF THE DRAWINGS

Further characteristics and advantages of the invention will become clearer from the following detailed description of some preferred exemplary embodiments thereof, illustrated by way of non-limiting example with reference to the appended drawings, in which:

FIG. 1 is a view in front elevation of a pair of spectacles produced according to the invention,

FIG. 2 is a view in side elevation of the spectacles of FIG. 1,

FIG. 3 is a view in section, on an enlarged scale, along the section line III-III of FIG. 1,

FIG. 4 is a view, corresponding to FIG. 1, of a pair of spectacles according to the invention with a lens during the mounting step,

FIG. 5 is a view on an enlarged scale of the detail of the spectacles indicated by the arrow C of FIG. 4,

FIG. 6 is a view of a detail of the invention,

FIG. 7 is a view of a variant of the invention shown by the detail of FIG. 6,

FIGS. 8 to 11 are views in section of alternative embodiments of a detail of the spectacles indicated in FIG. 3,

FIGS. 12 to 15 are views in section along the lines A-A of FIGS. 6 and 7,

FIG. 16 is a view in section along the lines B-B of FIGS. 6 and 7.

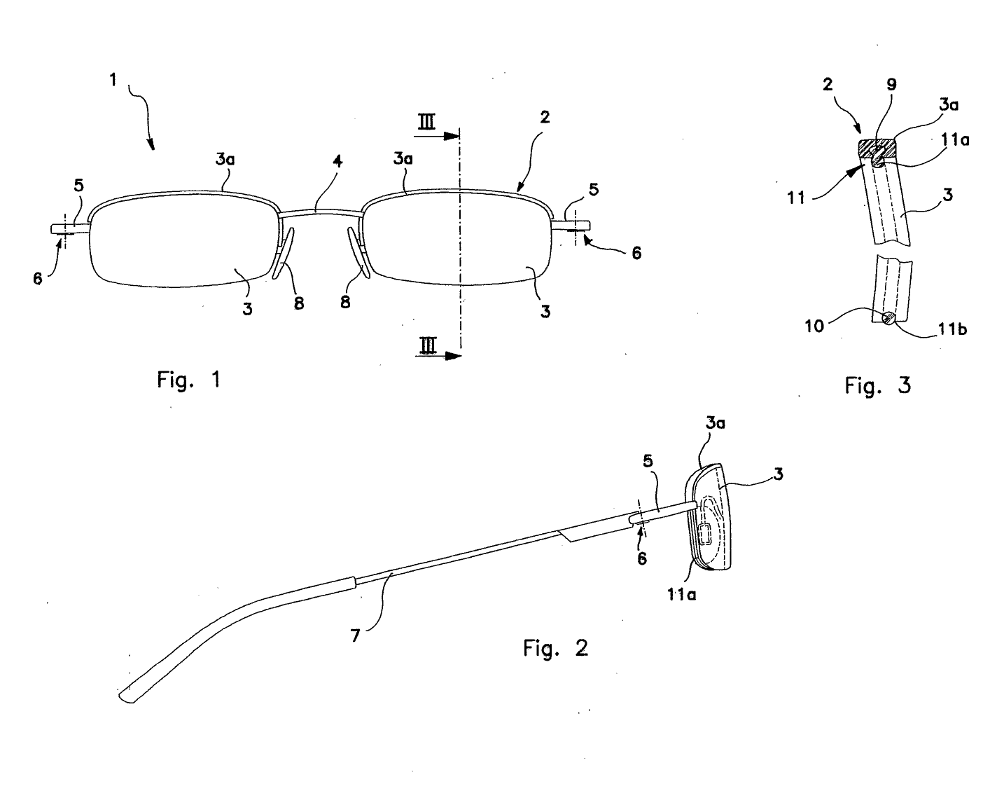

### DETAILED DESCRIPTION OF THE INVENTION

With reference to the figures mentioned, the reference 1 indicates as a whole a pair of spectacles produced according to the present invention, comprising a mounting 2 to which a pair of lenses 3 are connected by means of interconnecting means of the strap type. The mounting 2 comprises a pair of respective mounting members 3a, each of which extends in an arc in the region of the eyebrow arch. The members 3a are connected to each other by an intermediate bridge 4 located in the central nasal support region and are in turn connected, at their opposed lateral ends, to respective support arms 5 for hinges 6 for the articulation of mounting arms 7. The hinge supports 6 are also known by the term “lug” in the relevant technical field. The members 3a are further provided with respective nasal support pad, indicated as a whole by 8 in the figures.

The mounting members 3a are shaped so as to surround, closely following the shape thereof, corresponding portions of the edge of the respective lenses 3. Each mounting member 3a is further provided with a groove 9 running along the entire length of the mounting member 3a and open in a position facing the lens thickness. Said groove 9 is moreover open at its respective opposed ends.

In the thickness of each lens 3, along the entire peripheral edge thereof, a respective flute 10 is also provided, arranged for the connection, by strap means, to the corresponding mounting member 3a, as will be clearly revealed in the continuation of the description. Preferably, the flute 10 has in cross-section a circular arch profile or, as an alternative, another profile variable in general.

The strap interconnecting means comprise, for each lens 3, a single segment of strap 11, conveniently made of resiliently extensible material, for example of plastics material or materials having similar characteristics of resilience and flexibility, also comprising among them metallic materials. To this end, the strap 11 may advantageously be made of nylon, by means of injection moulding technology or by hot forming in a coining die or extrusion processing.

The segment of strap 11 comprises at least two segment lengths 11a, 11b, extending in prolongation of each other, and having a different cross-section. More particularly, the profile of the cross-section of the first length 11a is defined by a first and a second profile part, respectively indicated by 12a, 12b and connected to each other in a region of restricted intermediate cross-section, such as to impart to the entire cross-section a configuration which recalls, at least at a first approximation, a substantially figure-eight shape (FIG. 12).

The profile of the cross-section of the second strap length 11b has substantially the shape of the second profile part 12b, with the exception of the aforesaid connecting region, and preferably has a circular shape (FIG. 16).

Preferably, the cross-section of each of the strap lengths 11a, 11b is constant in the respective direction of longitudinal extension of the corresponding length.

For the connection of each lens 3 to the mounting 2, provision is made for the first strap length 11a to be retained by engagement in the respective groove 9 of each member 3a, and for the entire strap segment 11 to be extended to surround the peripheral lens edge by means of engagement of the second profile part 12b in the flute 10 of the lens. By means of suitable tensioning and coupling of the strap 11 to the mounting 2, the locking of the lens on the mounting is obtained, as will be explained in detail hereinafter.

For securing the strap segment 11 to the mounting 2, on each mounting member 3a coupling means are provided, comprising a pair of adjacent holes 13a, 13b passing through the corresponding member 3a. The holes are preferably located, on the member 3a, in proximity to its end adjacent to the intermediate bridge 4, and extend axially in a position facing the lens thickness 3.

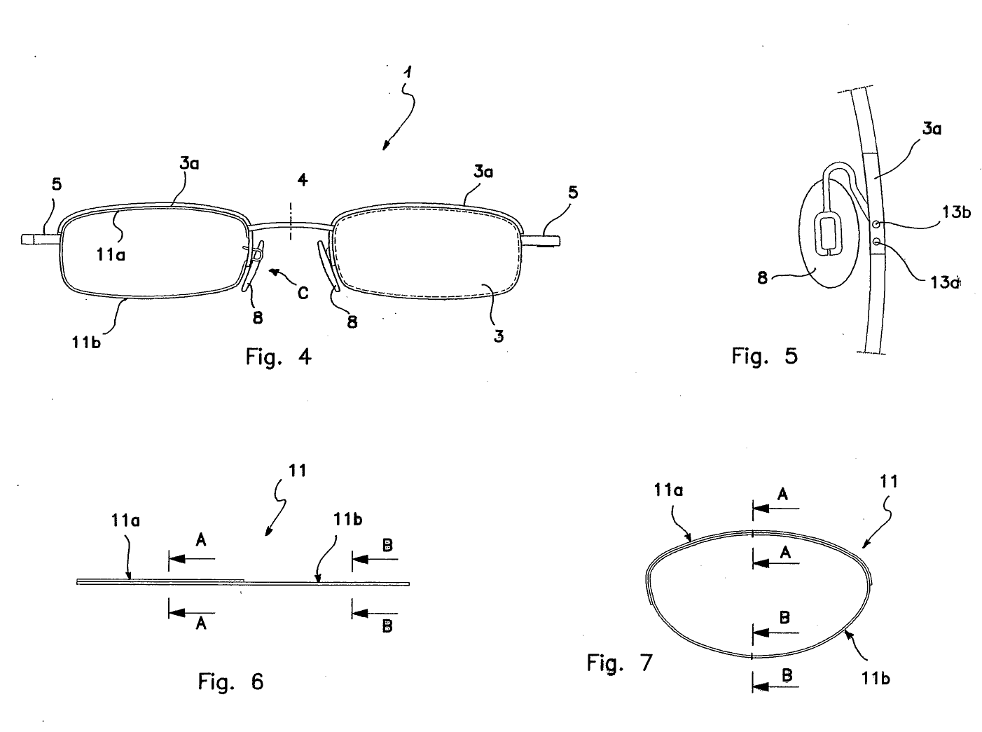

For the connection of the lens to the mounting, the strap segment 11 is initially inserted into the groove 9 by the corresponding length 11a, starting from the end of the mounting member 3a contiguous with the lateral lug 5, and by relative sliding between groove 9 and strap 11, the strap segment is caused to engage the groove almost completely, with consequent retention of the strap therein. This retaining action is ensured by the shape of the groove 9, which has, in cross-section, an internal groove cavity 9a, widened with respect to the opening 9b of the groove, so as to hinder the withdrawal of the strap from the groove in a direction transverse to the direction of sliding of the strap. In a subsequent step, the strap segment 11, subject to determination of a suitable length of the second length 11b (and cutting to size of said length, is secured to the mounting member 3a by means of coupling to the pair of holes 13a, 13b. An end portion of the strap length 11b is inserted into the hole 13a, from the inside towards the outside of the mounting, and is then inserted into the hole 13b, from the outside towards the inside, as clearly shown in FIG. 4. The free end of the strap length 11b therefore remains partly received in the flute 10.

In a subsequent operation, the lens 3 is placed against the corresponding mounting member 3a, with consequent engagement of the first strap length 11a in the corresponding and facing part of the flute 10 of the lens, and is locked by means of extension and engagement of the second strap length 11b in the remaining part of the flute 10. The interposition between mounting and lens of the first strap length 11a, having the profile 12b, makes it possible to produce an area of bearing of the lens on the mounting with characteristics of resilient yielding for improved adaptation of the lens (fragile material) to the mounting (rigid material) without the risk of breakage of the lens during the locking of same by means of tensioning of the strap 11.

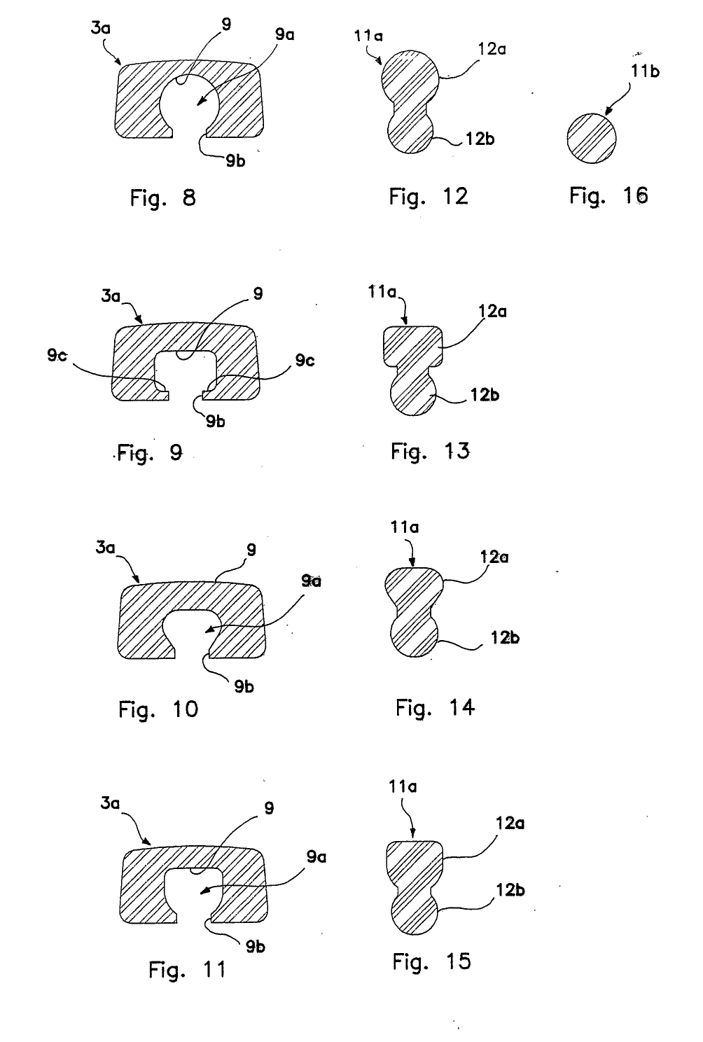

It should be noted that the relative locking between the first strap length 11a and the mounting member 3a is effected by the friction stresses generated between the surfaces in mutual contact of the groove 9 and of the strap length 11a retained therein. For the retention of the strap 11 in the groove 9, cross-sections of the groove having preselected geometric profiles are provided, designed as an alternative to one another and shown in FIGS. 8 to 11. It should be noted that a basic version of that section provides for a circular configuration of the inner groove cavity 9a with opposed lips 9c bounding the opening 9b of the groove. FIG. 9 shows a variant of the profile of the groove 9 having a quadrilateral configuration with rounded vertices, FIG. 10 shows a variant having an approximately triangular configuration, and FIG. 11 shows a variant obtained from a combination of the preceding configurations. It is to be understood that for each preselected configuration of the section of the groove 9, a corresponding cross-section of the first strap length 11a is provided for ensuring engagement of that length in the groove 9 with substantial form fitting. The provision of a more restricted groove opening 9b with respect to the dimension of the inner cavity 9a of the groove further makes it advantageously possible to effect the retention of the strap 11 in the groove even following predictable longitudinal deformations thereof due to the effect of its tensioning, which deformations may include a transverse reduction of the strap section engaged in the groove.

It is to be understood that for each lens a single strap 11 is provided (whether with open or closed contour, as described hereinafter), and that each lens is mounted as described previously with specific reference to only one of such lenses.

In a principal variant of the invention, in which details similar to those of the preceding example are designated by the same numerical references, provision is made for the strap segment 11 to be shaped in a closed ring, as clearly shown in FIG. 7. In this variant, cross-sections of the first strap length 11a similar to those of the preceding example are provided, for example those provided, as an alternative to one another, in FIGS. 12 to 15, with the provision of corresponding cross-sections of the groove 9 provided in the mounting member 3a (FIGS. 8 to 11).

With the closed ring configuration, the strap 11 may advantageously be secured to the mounting without any provision of coupling means with through holes, such as those described in the preceding example. A suitable choice of the dimensions of the ring in fact makes it possible to obtain in the tensioning of the strap the necessary forces for locking thereof against the lens without the need for auxiliary means for securing the strap itself. Moreover, on the basis of the resilient characteristics of the strap, it is possible to provide a length of the ring suitable for permitting the locking even of lenses having different gauges (dimensions). Advantageously, therefore, the same ring of strap may be used for mounting lenses of different styles and dimensions, thus facilitating and simplifying the cycles of production and assembly of the spectacles.

It should further be observed that, both with a strap having an open contour and one with a closed contour, provision is made to execute beveling on the inside of the profile, either in the region of the nose or in the region of the lug of the mounting, in order to prevent the escape of the strap after it has been coupled to the mounting.

Finally, it is pointed out that spectacles according to the invention may be obtained with mountings of different materials, in particular, but not exclusively, of plastics material.

The invention thus achieves the aims proposed, providing numerous advantages with respect to the known solutions.

A principal advantage lies in the fact that with the spectacles produced according to the invention, the structure of the mounting capable of receiving the lens is simplified with respect to the known solutions, at the same time facilitating the operations of the cycle of assembly of the lens on the mounting.

Another advantage lies in the greater constructional simplification of the connecting strap that can be produced as a single strap segment having a differentiated cross-section, with consequent reduction of the components and lower production and assembly costs. Yet another advantage lies in effecting the connection of lenses of different style and dimension with the same strap connecting means, obtaining an overall reduction of the components necessary for the range of spectacles produced.

1. Spectacles comprising a mounting and respective lenses and also a strap interconnecting means for the retention of the lenses on the mounting, said strap interconnecting means being capable of at least partially surrounding the lens and being secured to the mounting for retaining the lens thereon, said strap interconnecting means comprise, for each lens, a single strap segment with at least two lengths of segment having a different cross-section, the profile of the cross-section of one of the lengths being defined by a first and a second profile part the first profile part being capable of being retained in a respective grooved of the mounting, the second profile part of the cross-section being capable of engaging a peripheral flute provided in the lens thickness, and the profile of the cross-section of the other strap length having substantially the shape of said second profile part such that the other strap length surrounds the lens, engaging said flute.

2. The spectacles according to claim 1, wherein said strap segment comprises a first and a second length, extending in prolongation of one another, each length having a constant cross-section in the respective direction of longitudinal extension.

3. The spectacles according to claim 1, wherein the first length of strap segment has a cross-section defined by said first and second profile parts and is interposed between the mounting and the lens with retention in said groove of the mounting and engagement in said peripheral lens flute, means for coupling the strap being provided on the mounting for securing same and thus retaining the lens on the mounting with a preselected degree of tensioning of the strap.

4. The spectacles according to claim 3, wherein said coupling means comprise, for each lens, at least one pair of holes passing through the mounting in a position facing the thickness of the lens, an end portion of the second strap length being secured to the mounting by being inserted into one of said holes, from the inside towards the outside, and subsequently inserted into the other hole from the outside towards the inside, a free end of said second length being received in the flute in a position contained between the mounting and the lens.

5. The spectacles according to claim 4, wherein said mounting comprises a pair of mounting members, each capable of at least partially surrounding a respective lens and also mutually connected by an intermediate bridge, extending in proximity to a central nasal support region, said pair of holes being provided, in each of said mounting members, at said central nasal support region.

6. The spectacles according to claim 1, wherein said strap segment is made of plastics material.

7. The spectacles according to claim 5, wherein said strap segment is made of nylon.

8. The spectacles according to one claim 1, wherein said strap is made of resiliently extensible material.

9. The spectacles according to claim 1, wherein said strap segment is obtained by injection-moulding.

10. The spectacles according to claim 1, wherein said strap segment is obtained by hot forming in a coining die.

11. The spectacles according to claim 1, wherein said strap segment is obtained by means of extrusion processing.

12. The spectacles according to one claim 5, wherein said groove extends in the corresponding mounting member along the whole extent thereof and around the corresponding lens.

13. The spectacles according to claim 1, wherein each groove has a cross-section of a shape such as to receive with substantial form fitting the corresponding part of the transverse profile of the strap segment.

14. The spectacles according to claim 1, wherein said groove has, in cross-section, an inner groove cavity widened with respect to an inlet opening of the groove, such as to hinder the withdrawal of the strap from the groove transversely to the longitudinal direction of the groove.

15. The spectacles according to claim 14, wherein said groove is engaged by the corresponding profile of strap segment by the insertion of same at one of opposed ends of the groove and relative sliding between strap and groove in the longitudinal direction of the groove.

16. The spectacles according to claim 1, wherein the cross-section of the strap length defined by said first and second profile parts has a substantially figure-eight shaped contour.

17. The spectacles according to claim 1, wherein said second profile part has a substantially circular shape.

18. The spectacles according to claim 1, wherein said strap segment is shaped as a closed ring.

19. The spectacles according to claim 1, wherein the profile of said strap is deformed by beveling at one or both ends of the length of mounting in which it is retained, such as to prevent the escape of the strap from the mounting.

20. The spectacles according to claim 19, wherein said deformation by beveling is carried out at a lug region or an opposed nasal region of the mounting.

21. The spectacles according to claim 2, wherein the first length of strap segment has a cross-section defined by said first and second profile parts and is interposed between the mounting and the lens with retention in said groove of the mounting and engagement in said peripheral lens flute, means for coupling the strap being provided on the mounting for securing same and thus retaining the lens on the mounting with a preselected degree of tensioning of the strap.

22. Spectacles comprising a mounting and respective lenses and also a strap interconnector for the retention of the lenses on the mounting, said strap interconnector being capable of at least partially surrounding the lens and being secured to the mounting for retaining the lens thereon, said strap interconnector comprises, for each lens, a single strap segment with at least two lengths of segment having a different cross-section, the profile of the cross-section of one of the lengths being defined by first and second profile parts, the first profile part being capable of being retained in a respective groove of the mounting, the second profile part of the cross-section being capable of engaging a peripheral flute provided in the lens thickness, and the profile of the cross-section of the other strap length having substantially the shape of said second profile part such that the other strap length surrounds the lens, engaging said flute.
